(19) United States
(12) Patent Application Publication
(10) Pub. No.: US 2016/0372765 A1
(43) Pub. Date: Dec. 22, 2016

(54) COMBINED FUEL CELL STACK AND HEAT EXCHANGER ASSEMBLY

(71) Applicant: ENERGYOR TECHNOLOGIES INC, Saint-Laurent (CA)

(72) Inventors: Thomas David JONES, Montreal (CA); Michel Meyer BITTON, Saint-Laurent (CA)

(21) Appl. No.: 14/863,712

(22) Filed: Sep. 24, 2015

Related U.S. Application Data
(60) Provisional application No. 62/181,307, filed on Jun. 18, 2015.

(51) Int. Cl. H01M 8/04

(52) U.S. Cl. CPC H01M 8/04074

(57) ABSTRACT

Disclosed herein is a combined fuel cell and heat exchanger stack assembly. The assembly includes two electrically conductive plates, each plate having two sets of spaced apart fluid openings. The two sets of openings are spaced apart from each other. One or more fluid channels fluidly connect one fluid opening in one set with one fluid opening in the other set. A heat exchanger plate has two sets of spaced apart heat exchanger fluid openings. The two sets of heat exchanger openings are spaced apart from each other. One or more fluid channels fluidly connect one heat exchanger fluid opening in one set with one heat exchanger fluid opening in the second set. The heat exchanger plate is sandwiched between the electrically conductive plates so that the spaced apart fluid openings in the plates and the fluid channels are in fluid communication with each other. The plates are configured such that thermal energy generated at the heat exchanger plate preheats a fuel cell fluid reactant as it enters one fluid channel in the second electricially conductive plate at a first temperature to a second temperature by thermal energy transfer from the heat exchanger plate.

### CROSS-REFERENCE TO RELATED APPLICATION

The Applicants hereby claim priority to previously field U.S. provisional patent application Ser. No. 62/181,307, filed on Jun. 18, 2015, the contents of which are hereby incorporated by reference.

### TECHNICAL FIELD

The present generally concerns electrochemical fuel cells and more particularly to a fuel cell stack with an integrated heat exchanger.

### BACKGROUND

Polymer electrolyte membrane or proton exchange membrane (PEM) fuel cell systems have intrinsic benefits and a wide range of applications due to their relatively low operating temperatures and good balance specific power, power density, specific energy and energy density. The active portion of a PEM cell is a membrane sandwiched between an anode and a cathode layer. Fuel containing hydrogen is passed over the anode and oxygen (air) is passed over the cathode. The reactants, through the electrolyte membrane, react indirectly with each other generating an electrical voltage between the cathode and anode. Typical electrical potentials of PEM cells can range from 0.5 to 0.9 volts where the higher the cell voltage, the greater the electrochemical efficiency. At lower cell voltages, the current density is higher but there is eventually a peak value in power density for a given set of operating conditions. The electrochemical reaction also generates heat and water as byproducts that must be extracted from the fuel cell, although the extracted heat can be used in a cogeneration mode, and the product water can be used for humidification of the membrane, cell cooling or dispersed to the environment.

Multiple cells are combined by stacking, interconnecting individual cells in an electrical series configuration. The voltage generated by the fuel cell stack is effectively the sum of the individual cell voltages. There are designs that use multiple cells in parallel or in a combination series-parallel connection. Fluid flow field plates are inserted between the cells to separate the anode reactant of one cell from the cathode reactant of the next cell. These plates are typically graphite based or metallic in nature. To provide hydrogen to the anode and oxygen to the cathode without mixing, a system of fluid distribution and seals is required.

The dominant design at present in the fuel cell industry is to use fluid flow field plates with the flow fields machined, molded or otherwise impressed. An optimized flow field plate has to fulfill a series of requirements: very good electrical and heat conductivity; gas tightness; corrosion resistance; low weight; and low cost. The fluid flow field plate design ensures good fluid distribution as well as the removal of product water and heat generated. Manifold design is also critical to uniformly distribute fluids between each separator/flow field plate.

There is an ongoing effort to innovate in order to increase the specific power and power density (reduce weight and volume) of fuel cell stacks, balance-of-plant (BOP), and hydrogen storage systems, and also to reduce material and assembly costs.

In a fuel cell system (stack & balance of plant), the stack is the dominant component of the fuel cell system's weight and cost and the fluid flow field plates are the major component (both weight and volume) of the stack.

Fluid flow field plates are a significant factor in determining the specific power and power density of a fuel cell, typically accounting for 40 to 70% of the weight of a stack and almost all of the volume. For component developers, the challenge is therefore to reduce the weight, size and cost of the fluid flow field plate while maintaining the desired properties for high-performance operation.

The material for the fluid flow field plate must be selected carefully due to the challenging environment in which it operates. In general, it must possess a particular set of properties and combine the following characteristics:
High electrical conductivity, especially in through-plane direction
Low contact resistance with the gas diffusion layer (GDL)
High thermal conductivity, both in-plane and through-plane
Good thermal stability, limiting expansion and contraction due to temperature variations
Good mechanical strength and resistance to cracking
Able to maintain good feature tolerance for flow fields, etc.
Fluid impermeability to prevent reactant and coolant leakage, especially for the case of gaseous hydrogen
Corrosion resistance
Resistance to ion-leaching, so as not to contaminate the membrane electrode assembly (MEA)
Thin and lightweight
Low cost and ease of manufacturing
Recyclable
Environmentally benign

There is also an ongoing effort to increase the specific energy and energy density of the fuel cell system's fuel source. Various practical hydrogen storage methods are available such as high pressure hydrogen cylinders, chemical and metal hydrides, but none of these are more energy dense than hydrogen storage in its liquid form. Hydrogen can be maintained as a liquid at 20.37 Kelvin (−253.78 Celsius) and 1 atmosphere where its density is 70.85 kg/m³. To be used as a reactant in a fuel cell stack, the hydrogen must be evaporated into its gaseous form, and then preheated before it is introduced to the anode of the fuel cell stack. Evaporation generally occurs within the liquid hydrogen storage tank using an integrated heater. The cold hydrogen gas then leaves the liquid hydrogen tank and is usually fed through a separate, standalone heat exchanger to preheat the hydrogen gas.

A number of different methods have been used to integrate a heat exchanger into the structure of a fuel cell stack.

U.S. Pat. No. 8,383,280 to Niroumand for “Fuel Cell Separator Plate with Integrated Heat Exchanger” on Feb. 26, 2013, describes a fuel cell separator plate having a planar substrate having a main body with first and second opposed major surfaces, a first open channel reactant flow field recessed in the first major surface, and a first segment extending from the main body, and a thermally and electrically conductive first current collector layer having a flow field portion on the first major surface of the main body and a heat exchange portion extending from the flow field portion onto the first segment such that heat in the flow field portion conducts to the heat exchange portion during fuel cell use.

U.S. Pat. No. 7,579,099 to Lee et al for “Fuel Cell Having Heat Exchanger Built in Stack” on Aug. 25, 2009, describes a fuel cell having a heat exchanger that has a structure suitable for reducing space occupancy of the fuel cell. The fuel cell includes a stack where a chemical reaction for transforming chemical energy of a fuel into electricity occurs and a heat exchanger that removes heat generated during the energy transformation process in the stack, wherein the heat exchanger is built in at least one plate mounted on the stack. Therefore, the occupancy of the fuel cell can be reduced to be approximately half of a conventional externally mounted type heat exchanger.

U.S. Pat. No. 7,226,682 to Tachtler et al for “Fuel Cell with Integrated Heat Exchanger” on Jun. 5, 2007, describes a fuel cell includes at least one individual cell with an electrolyte/electrode unit, as well as at least one conducting end or intermediate plate, via which a gaseous reactant can be supplied to an electrode at least in one inlet region. In order to lower power losses, as well as the need for gas circulation, the end or intermediate plate is designed so that in terms of flow, a heat exchange region is incorporated before an inlet region, and heat is removed from an anode side of the individual cell in the heat exchanger.

U.S. Pat. No. 7,393,605 to Blanchet et al for “Fuel Cell End Unit with Integrated Heat Exchanger” on Jul. 1, 2008, describes an end unit for a fuel cell stack having a plurality of fuel cell stacked in a first direction, the end unit for stacking in the first direction adjacent an end fuel cell in the fuel cell stack. The end unit separates a current collection post from the end cell of the fuel cell stack and comprises a first wall being adjacent the end cell when the end unit is stacked in the first direction in the fuel cell stack, a second wall opposing the first wall and adjacent the current collection post when the end unit is stacked in the first direction in the stack, a first side wall connecting the first and second walls, a second side wall transverse to the first side wall and connecting the first and second walls, a third side wall opposing the first side wall and connecting the first and second walls, a fourth side wall opposing the second side wall and connecting the first and second walls, with the first and second walls and the first, second, third and fourth side walls forming an enclosure, and a plurality of electrically conductive posts disposed within the enclosure and extending between the first and second walls for providing a structure which restricts electrical current flow from the first fuel cell stack to the current collection post when the end unit is stacked in the first direction in the fuel cell stack.

U.S. Pat. No. 8,568,937 to Formanski et al for “Fuel Cell Design with an Integrated Heat Exchanger and Gas Humidification Unit” on Oct. 29^{th}, 2013, describe a fuel cell assembly having a flow distribution subassembly that comprises four sets of flow channels, the first set facing an anode for distribution of a fuel reactant to said anode, the second set facing a cathode for distribution of an oxidant to said cathode, the third set in flow communication with said second set and in heat transfer relation with at least one of said anode and said cathode, and the fourth set receiving a coolant different from said oxidant.

Published United States patent application no. 20050037253 from Faghri for “Integrated Bipolar Plate Heat Pipe for Fuel Cell Stacks” on Feb. 17, 2005, describes a system and method for distributing heat in a fuel cell stack through a bipolar interconnection plate that incorporates heat pipe technology within the bipolar plate body to form a bipolar interconnection plate heat pipe combination for improved thermal management in fuel cell stacks.

Thus, there is a need for an improved integrated a heat exchanger and fuel cell assembly for preheating cold, gaseous hydrogen fuel when it evaporates from a liquid hydrogen storage system.

### BRIEF SUMMARY

We have designed an autonomous integrated fuel cell and heat exchanger assembly, which diverts thermal energy (heat), generated at the heat exchanger plate, from the heat exchanger to pre-heat reactant fluid, in particular hydrogen gas, as it evaporates and enters the assembly from a liquid hydrogen storage system. The heat would otherwise be lost to the environment. Cold hydrogen gas passes through the integrated heat exchanger plates “on demand”. As the hydrogen is consumed in the stack, it is replaced as needed. The heat exchanger plates within the stack replace a separate, stand-alone heat exchanger that would be heavy and add complexity to the assembly. Furthermore, the separate heat exchanger would require an electric heater or piping from the stack's coolant system (in a liquid cooled configuration) to warm the incoming hydrogen.

Accordingly, there is provided a combined fuel cell and heat exchanger stack assembly comprising:

a first electrically conductive plate having first and second sets of spaced apart fluid openings, the first and second sets of openings being spaced apart from each other, at least one fluid channel fluidly connecting one fluid opening in the first set with at least one fluid opening in the second set;

a second electrically conductive plate having first and second sets of spaced apart fluid openings, the first and second sets of openings being spaced apart from each other, at least one fluid channel fluidly connecting one fluid opening in the first set with at least one fluid opening in the second set;

a heat exchanger plate having a first and second sets of spaced apart heat exchanger fluid openings, the first and second sets of heat exchanger openings being spaced apart from each other, at least one fluid channel fluidly connecting one heat exchanger fluid opening in the first set with at least one heat exchanger fluid opening in the second set, the heat exchanger plate being sandwiched between the first and second electrically conductive plates so that the spaced apart fluid openings in the plates and the fluid channels are in fluid communication with each other;

the first electrically conductive plate, the second electrically conductive plate and the heat exchanger plate being configured such that thermal energy generated at the heat exchanger plate preheats a fuel cell fluid reactant as it enters the at least one fluid channel in the second electrcially conductive plate at a first temperature to a second temperature by thermal energy transfer from the heat exchanger plate.

In one example, the first electrcially conductive plate includes a first set of three manifold openings located near a first plate edge and a second set of three manifold openings located near a second plate edge opposite the first plate edge.

In one example, the second electrically conductive plate includes a first set of three manifold openings located near a first plate edge and a second set of three manifold openings located near a second plate edge opposite the first plate edge.

In another example, the heat exchanger plate includes a first set of three manifold openings located near a first plate edge and a second set of three manifold openings located near a second plate edge opposite the first plate edge.

In one example, the first electrically conductive plate includes first and second cooling fins connected to the plate and extending extending away therefrom, the cooling plates being respectively connected to a third and a fourth plate edge.

In one example, in the first electrically conductive plate the first set of the three manifold openings includes: an oxidant outlet manifold opening, a heat exchanger inlet manifold opening and an anode outlet manifold opening; and the second set of the three manifold openings includes: an oxidant inlet manifold opening, a heat exchanger outlet manifold opening and an anode inlet manifold opening.

In another example, the at least one fluid channel connects the anode inlet manifold opening to the anode outlet manifold opening. Three fluid channels connects the anode inlet manifold opening to the anode outlet manifold opening. The fluid channels are serpentine.

In one example, the at least one fluid channel is located on one side of the first electrically conductive plate.

In another example, the first electrically conductive plate is an anode plate.

In another example, in the second electrically conductive plate the first set of the three manifold openings includes: an oxidant outlet manifold opening, a heat exchanger inlet manifold opening and an cathode outlet manifold opening; and the second set of the three manifold openings includes: an oxidant inlet manifold opening, a heat exchanger outlet manifold opening and an cathode inlet manifold opening. The at least one fluid channel connects the anode inlet manifold opening to the anode outlet manifold opening. Three fluid channels connect the anode inlet manifold opening to the anode outlet manifold opening. The fluid channels are serpentine.

In one example, the at least one fluid channel is located on one side of the second electrically conductive plate.

In yet another example, the first electrically conductive plate is a cathode plate.

In still another example, in the heat exchanger plate the first set of the three manifold openings includes: an oxidant outlet manifold opening, a heat exchanger inlet manifold opening and an cathode outlet manifold opening; and the second set of the three manifold openings includes: an oxidant inlet manifold opening, a heat exchanger outlet manifold opening and an cathode inlet manifold opening. The at least one fluid channel connects the anode inlet manifold opening to the anode outlet manifold opening. Three fluid channels connects the anode inlet manifold opening to the anode outlet manifold opening. The fluid channels are serpentine.

In one example, in each of the first electrically conductive plate, the second electrically conductive plate and the heat exchanger plate, the fluid channels are located on one side of the plate, the other side of each plate has a smooth surface. The fluid channels of each plate are orienated such that the fluid channels on the heat exchanger plate are in intimate contact with the smooth surface of the first electrically conductive plate and the smooth surface of the heat exchanger plate is in intimate contact with the smooth surface of the second electrically conductive plate, the fluid channels of the first electrically conductive plate and the fluid channels of the second electrically conductive plate being disposed away from each other.

In one example, the fuel cell fluid reactant is hydrogen gas. The hydrogen gas is preheated to the first temperature, the first temperature being at least 20.37 K (−252.78 C).

In one example, the second temperature of the preheated hydrogen gas is 60° C. The second temperature is the operating temperature of the stack.

In another example, the reactant gas exits the assembly at a third temperature, the third temperature being 60° C.

In another example, the cooling fins are connected to the anode plate and extend away therefrom.

In yet another example, the cooling fins are connected to the cathode plate and extend away therefrom.

In yet another example, the cooling fins are connected to the heat exchanger plate and extend away therefrom.

In yet another example, two of the fluid openings in both sets in each of the first and second electrically conductive plates, and the heat exchanger plate, are fluid reactant openings.

In still another example, the at least one fluid channel extends between the two fluid openings.

In yet another example, three fluid channels extend between the two fluid openings.

In yet another example, the three fluid channels are disposed substantially parallel to each other.

Accordingly, in another aspect there is provided a combined fuel cell and heat exchanger stack assembly, the assembly comprising:

a plurality of combined fuel cell and heat exchange assemblies, as described above, stacked on each other;

a plurality of cooling fins extending away from the stack, the cooling fins being located on opposite sides of the stack, the cooling fins being connected to opposite sides of each first electrically conductive plate;

an upper end plate and a lower end plate located in intimate contact with respectively an end first electrically conducitve plate and an end second electrically conductive plate.

In one example, the lower end plate includes an anode outlet manifold port, a heat exchanger inlet manifold port and an oxidant outlet manifold port.

In another example, the upper end plate includes an anode inlet manifold port, a heat exchanger outlet manifold port and an oxidant inlet manifold port.

In another example, the assembly operates autonomously.

Accordingingly in another aspect, there is provided a method for preheating a fuel cell reactant gas for use in a fuel cell stack, the method comprising:

heating a fuel cell fluid reactant as it enters an at least one fluid channel in a first electrically conductive plate, at a first temperature, from the first temperature to a second temperature by diverting thermal energy generated at a heat exchanger plate, the heat exchanger plate being sandwiched between the first electrically conductive plate and a second electrically conductive plate, the plates being in fluid communication with each other.

### BRIEF DESCRIPTION OF THE DRAWINGS

These and other features of that described herein will become more apparent from the following description in which reference is made to the appended drawings wherein:

FIG. 1 is a perspective top view of a fuel cell bipolar plate assembly with integrated heat exchanger flow field plate;

FIG. 2 is a perspective worm's eye view of the assembly of FIG. 1;

FIG. 3 is a perspective, exploded top view of the fuel cell bipolar plate assembly showing the serpentine fluid flow channels in the anode plate and the heat exchanger plate;

FIG. 4 is a perspective, exploded worm's eye view of the assembly of FIG. 3 showing the serpentine fluid flow channels in the cathode plate;

FIG. 5 is a perspective top, front view of a fuel cell stack incorporating the bipolar plate assembly with integrated heat exchanger flow field plate showing an upper end plate with an anode inlet manifold port, a heat exchanger outlet manifold port, an oxidant inlet air manifold port, and a plurality of cooling fins; and

FIG. 6 is a perspective top, rear view of FIG. 5 showing a lower end plate with an anode outlet manifold, a heat exhanger inlet manifold port, an oxidant outlet air manifold port, and the plurality of cooling fins.

### DETAILED DESCRIPTION

### Definitions

Unless otherwise specified, the following definitions apply:

The singular forms “a”, “an” and “the” include corresponding plural references unless the context clearly dictates otherwise.

As used herein, the term “comprising” is intended to mean that the list of elements following the word “comprising” are required or mandatory but that other elements are optional and may or may not be present.

As used herein, the term “consisting of” is intended to mean including and limited to whatever follows the phrase “consisting of”. Thus, the phrase “consisting of” indicates that the listed elements are required or mandatory and that no other elements may be present.

As used herein, the term “flow field plate” is intended to mean a plate that is made from a suitable electrically conductive material. The material is typically substantially fluid impermeable, that is, it is impermeable to the reactants and coolants typically found in fuel cell applications, and to fluidly isolate the fuel, oxidant, and coolants from each other. In the examples described below, an oxidant flow field plate is one that carries oxidant, whereas a fuel flow field plate is one that carries fuel, and a heat exchanger flow field plate is one that carries cold gaseous fuel. The flow field plates can be made of the following materials: graphitic carbon impregnated with a resin or subject to pyrolytic impregnation; flexible graphite; metallic material such as stainless steel, aluminum, nickel alloy, or titanium alloy; carbon-carbon composites; carbon-polymer composites; or the like. Flexible graphite, also known as expanded graphite, is one example of an especially suitable material for fabricating fluid flow field plates.

As used herein, the term “fluid” is intended to mean liquid or gas. In particular, the term fluid refers to the reactants and coolants typically used in fuel cell applications.

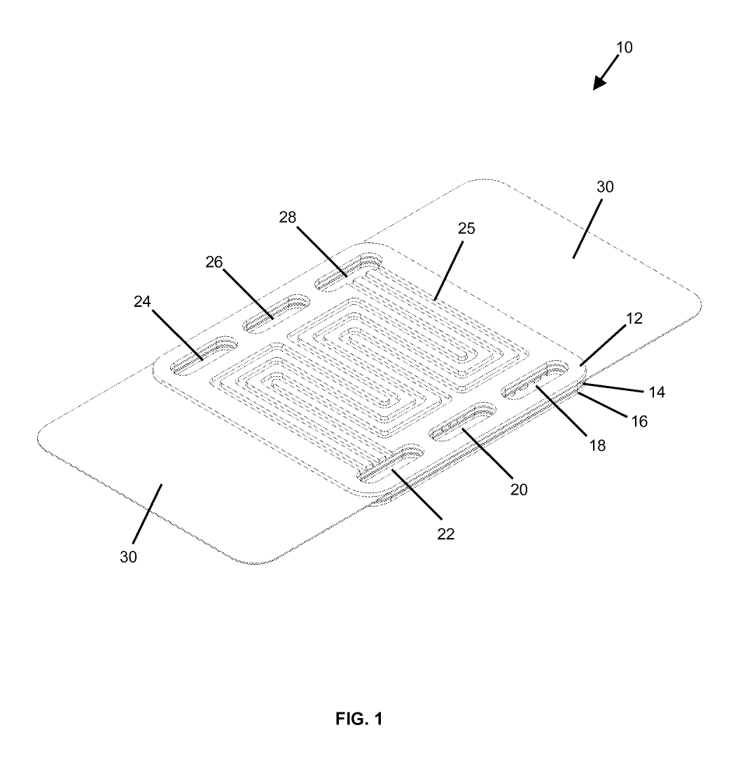

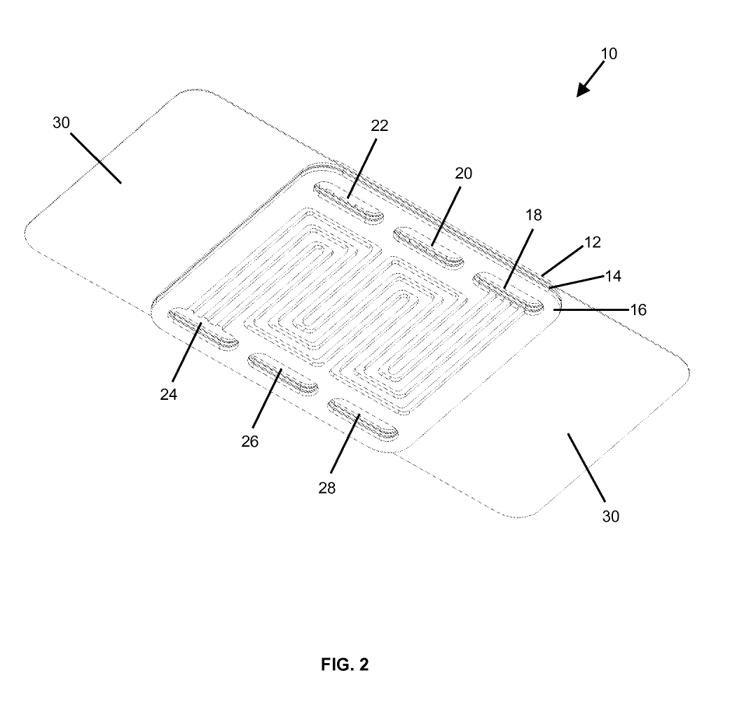

Referring now to FIGS. 1, 2 and 3, a combined fuel cell bipolar plate assembly with integrated heat exchanger flow field plate is shown generally at 10. The bipolar plate assembly 10 comprises a first electrically conductive anode flow field plate 12, a heat exchanger flow field plate 14, and a second electrically conductive oxidant (cathode) flow field plate 16 which are located in intimate contact with each other, the heat exchanger plate 14 being sandwiched between the anode field plate 12 and the oxidant flow field plate 16.

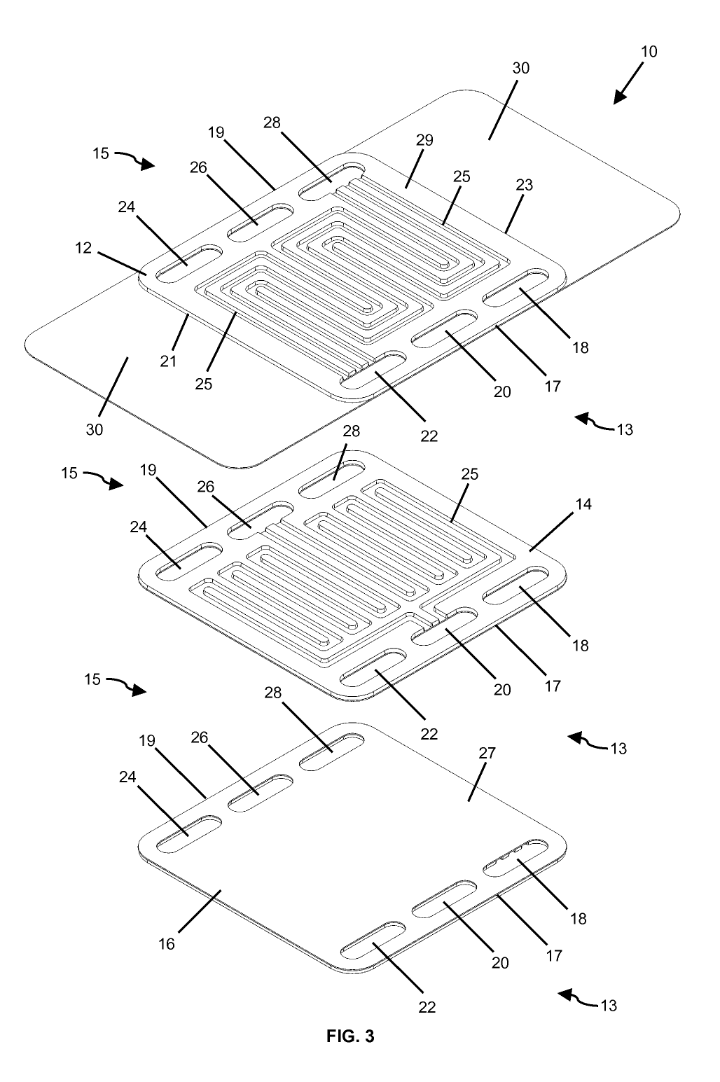

Referring now to FIG. 3, the anode flow field plate 12 includes first and second sets of spaced apart fluid openings 13, 15. The first set of fluid openings 13 are located near a first plate edge 17 and the second set of fluid openings 15 are located near a second plate edge 19 opposite the first plate edge 17. The first set of fluid openings 13 includes three spaced apart fluid openings, namely an oxidant inlet manifold opening 18, a heat exchanger outlet manifold opening 20 and an anode inlet manifold opening 22. The second set of fluid openings 15 includes three spaced apart fluid openings, namely an oxidant outlet manifold opening 24, a heat exchanger inlet manifold opening 26 and an anode outlet manifold opening 28.

Still referring to FIG. 3, each heat exchanger plate 14 and oxidant flow field plate 16 includes the first and second sets of spaced apart fluid openings 13, 15. In each plate 14, 16, the first set of fluid openings 13 are located near the first plate edge 17 and the second set of fluid openings 15 are located near the second plate edge 19 opposite the first plate edge 17. In each plate 14, 16, the first set of fluid openings 13 includes three spaced apart fluid manifold openings, namely an oxidant inlet manifold opening 18, a heat exchanger outlet manifold opening 20 and an anode inlet manifold opening 22. Finally, in each plate 14, 16, the second set of fluid manifold openings 15 includes three spaced apart fluid openings, namely an oxidant outlet manifold opening 24, a heat exchanger inlet manifold opening 26 and an anode outlet manifold opening 28.

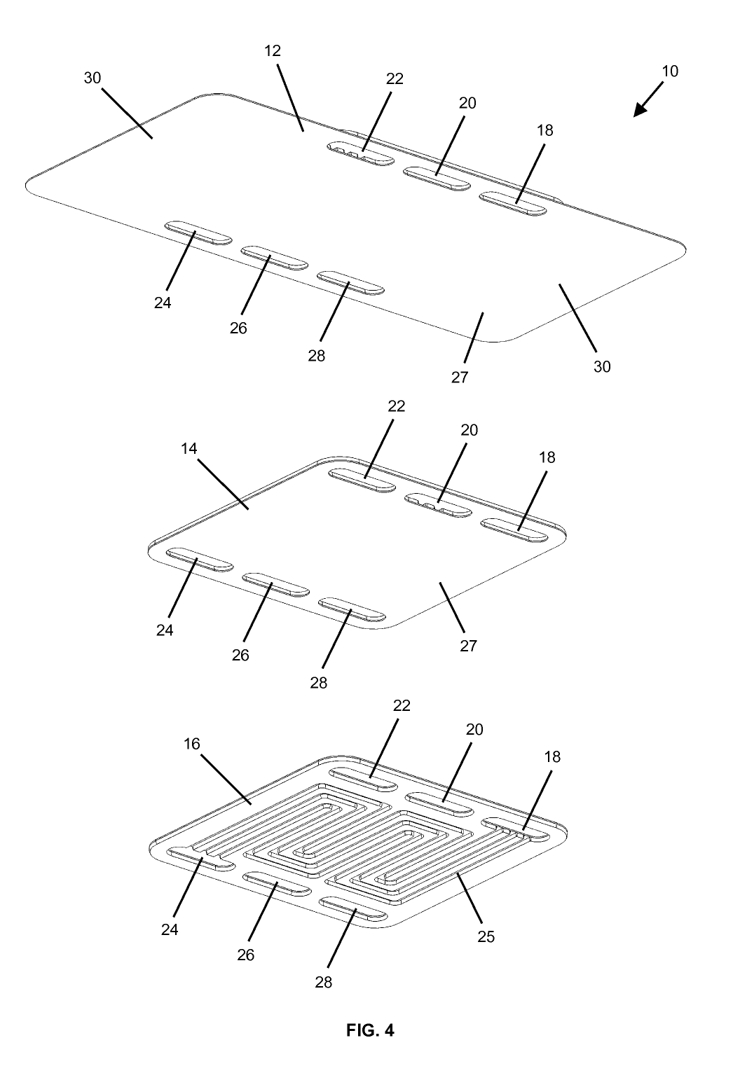

As best illustrated in FIGS. 3 and 4, the oxidant inlet manifold opening 18 and the oxidant outlet manifold opening 24 are aligned in each of the flow field plates 12, 14 and 16. Similarly, the heat exchanger inlet manifold opening 26 and the heat exchanger outlet manifold opening 20 are also aligned, as well as the anode inlet manifold opening 22 and the anode outlet manifold opening 28 in the flow field plates 12, 14 and 16. In the example illustrated, two cooling fins 30 are connected to and extend away from the anode flow field plate 12. The cooling plates 30 are respectively connected to a third and a fourth plate edge 21, 23. The inventors also contemplate incorporating the cooling fins 30 into either of the other two flow field plates 14 or 16.

Still referring to FIGS. 3 and 4, broadly speaking the anode flow field plate 12 includes at least one fluid channel 25 which fluidly connects one of the fluid openings in the first set of openings 13 with at least one of the fluid openings in the second set of openings 15. Similarly each heat exchanger plate 14 and oxidant flow field plate 16 includes at least one fluid channel 25 which fluidly connects one fluid opening in the first set of openings 13 with at least one fluid opening in the second set of openings 15. In the example shown, the channel 25 fluidly connects the anode inlet manifold opening 22 in each of the plates 12, 14 and 16 to the anode outlet manifold opening 28 in each of the plates 12, 14 and 16. In the example shown, three fluid channels 25 extends between the openings 22 and 28 and fluidly connects them. The three fluid channels 25 are disposed substantially parallel to each other and are disposed in a serpentine flow field pattern. The plates 12, 14, 16 each has a smooth surface 27 and a channeled surface 29. Thus, when sandwiched together, the plates 12, 14, 16 are configured such that the oxidant inlet manifold opening 18 and the oxidant outlet manifold opening 24 are aligned in each of the flow field plates 12, 14 and 16. Similarly, the heat exchanger inlet manifold opening 26 and the heat exchanger outlet manifold opening 20 are also aligned, as well as the anode inlet manifold opening 22 and the anode outlet manifold opening 28 in the flow field plates 12, 14 and 16.

Referring again to FIGS. 3 and 4, the fluid channels 25 of each of the plates 12, 14, 16 are orienated such that the fluid channels 25 on the heat exchanger plate 14 are in intimate contact with the smooth surface 27 of the first electrically conductive plate 12 and the smooth surface 27 of the heat exchanger plate 14 is in intimate contact with the smooth surface 27 of the second electrically conductive plate 16. The fluid channels 25 of the first electrically conductive plate 14 and the fluid channels 25 of the second electrically conductive plate 16 are disposed away from each other.

In its basic form, the assembly 10 includes the first electrically conductive plate 12, the second electrically conductive plate 16 and the heat exchanger plate 14. The plates are configured such in operation that thermal energy that is generated at the heat exchanger plate 14 preheats a fuel cell fluid reactant as it enters the fluid channel 25 from a liquid hydrogen source (not shown) in the second electrically conductive plate 16 at a first temperature to a second temperature by thermal energy transfer from the heat exchanger plate 14. The fuel cell fluid reactant is hydrogen gas is preheated to the first temperature which is at least 20.37 K (−252.78 C). The heated hydrogen gas attains the second temperature of 60° C., which is the operating temperatire of the assembly 10. The reactant gas exits the assembly 10 at a third temperature which is also 60° C.

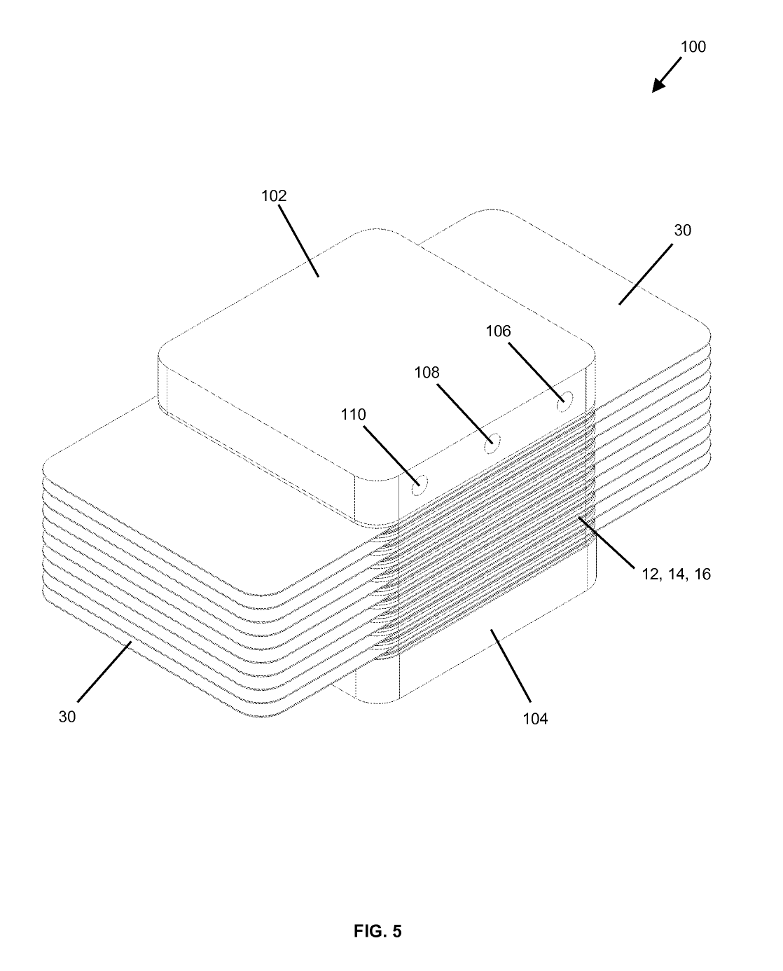

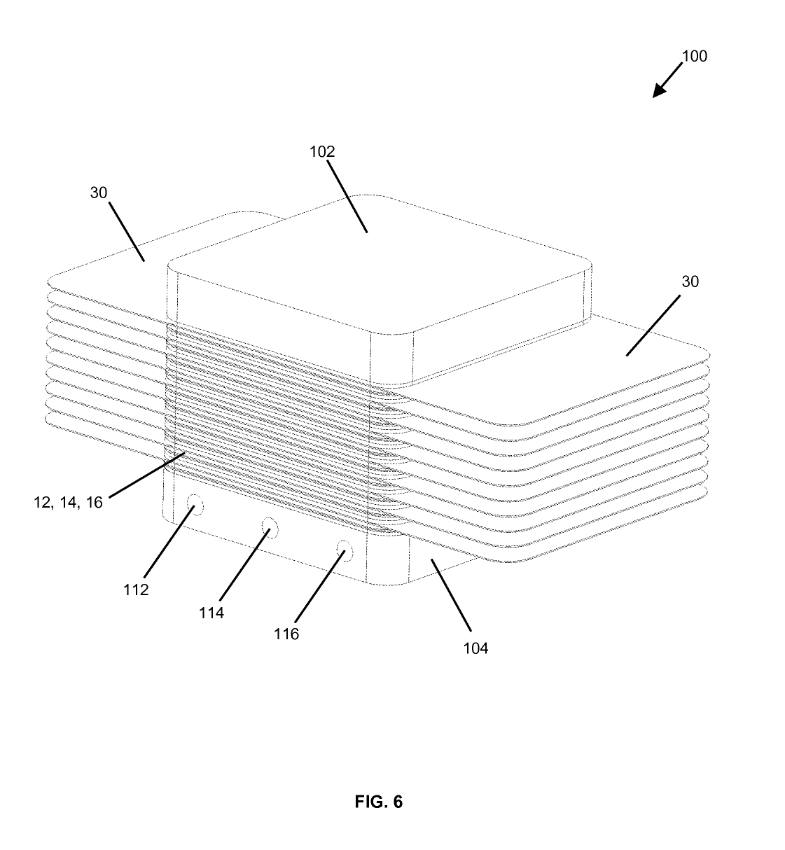

Referring now to FIGS. 1, 2, 5 and 6, the assembly 10 can also be described as a sub assembly because it represents a single modular component which when combined with a plurality of other subassemblies forms an autonomously operated fuel cell stack 100. Oxidant reactant air enters the oxidant inlet air manifold port 106 in an upper end plate 102, passes through the series of oxidant flow field plates 16, and exits at an oxidant outlet air manifold port 116 in a lower end plate 104. Cold gaseous hydrogen fuel from a liquid hydrogen storage tank (not shown) enters at a heat exchanger inlet manifold port 114 in the lower end plate 104, passes through a series of heat exchanger flow field plates 14, and exits at a heat exchanger outlet manifold port 108 in an upper end plate 102. The preheated, warm gaseous hydrogen fuel leaving the heat exchanger outlet manifold port 108 is then routed to an anode inlet manifold port 110, where it passes through a series of anode flow field plates 12 and is consumed in the fuel cell reaction. Excess hydrogen fuel not consumed exits at an anode outlet manifold port 112. A pluarlity of integrated cooling fins 30 permit the fuel cell stack 100 to be air cooled.

The fuel cell stacks described herein are particularly well suited for use in fuel cell systems for unmanned aerial vehicle (UAV) applications, which require very lightweight fuel cell and hydrogen fuel storage systems with high specific energy and energy density. Other uses for the lightweight fuel cell stacks include auxiliary power units (APUs) and small mobile applications such as scooters. Indeed, the fuel cell stacks may be useful in many other fuel cell applications such as automotive, stationary and portable power.

### Alternatives

The heat exchanger flow field plate design and number of heat exchanger flow field plates may be adjusted according to the amount of preheating required by the cold, incoming gaseous hydrogen and desired anode inlet temperature. Further, the amount of preheating would be indirectly, passively controlled via a pressure regulator in the anode loop. When gaseous hydrogen fuel is consumed, the pressure in the anode loop drops, and more cold gaseous hydrogen would flow into the fuel cell stack to maintain a specific preset hydrogen pressure in the anode loop. This would only occur when the stack is producing more power, and therefore more waste heat. Effectively, the preheating of the cold gaseous hydrogen would be self-regulated depending on the power required from the fuel cell stack and corresponding waste heat produced.

The cold gaseous hydrogen entering the stack from the liquid hydrogen storage system would act to remove waste heat from the stack, thereby improving the systems overall efficiency and reducing the amount of air cooling required via the cooling fins.

A unitary body (the subassembly or assembly 10) can be manufactured easily by merely integrating the heat exchanger plate between the anode and oxidant fuel plates and then mechanically or adhesively bonding them together by a pressing force, or using silicone adhesive, respectively; this would create a bipolar plate. For the silicone adhesive case, a thin adhesive layer may be applied to the perimeter of the plates and not to the cell's active area section to maintain intimate contact between the flexible graphite plates, thereby reducing electrical contact resistance.

A “hybrid” laminate structure is also contemplated which may include flexible graphite fluid flow channels, and a very thin aluminum or stainless steel separator plate. These subcomponents could also be mechanically or adhesively bonded together to create one part. In this case, the adhesive would again not be applied to the active area portion of the bipolar plate.

The plates can be manufactured with a high volume manufacturing process (reciprocal or rotary die-cutting commonly used in label making) therefore reducing overall part cost.

Parts can be manufactured using very low cost tooling (flat or cylindrical flexible dies). Moreover, flexible graphite raw material is inexpensive and is available in various forms and thicknesses.

Flexible graphite has a typical density of 1.12 g/cc. Pure graphite typically used for machining bipolar plates has a density of approximately 2.0 g/cc (1.79 times more). Graphite used for molded bipolar plates can achieve a density as low as 1.35 g/cc (1.2 times more) but requires expensive injection molding equipment and cavity dies. Additionally, flexible graphite bipolar plates fabricated via die-cutting have reduced mass because material is removed for flow channels and manifolds.

Fluid flow channel depth may be changed easily by changing the thickness of flexible graphite sheet and using same die. Also, a modular bipolar plate allows for various fuel cell configurations. For example, if more cooling is required for a specific application, a larger cooling fin can be substituted permitting higher heat removal.

Alternatively, instead of using a separate heat exchanger fluid flow field plate, the heat exchanger section can be incorporated into the anode fluid flow field plate in a section outside of the active area, but in the same plane. For example, the cold hydrogen gas would enter the anode manifold and then on to the anode flow field plates, passing through several flow channels (i.e. two or three serpentine passes) outside of the active area to preheat the cold reactant hydrogen gas, and then once it is warmed up, it would enter the anode section of the fuel cell's active area for the reaction to proceed. This would act to preheat the reactant hydrogen, but also to cool the fuel cell stack by removing waste heat. This alternative design would also permit the fuel cell stack to be shorter by removing the separate heat exchanger plate, but would increase the overall area of the flow field plates, end plates, and the like.

### OTHER EMBODIMENTS

From the foregoing description, it will be apparent to one of ordinary skill in the art that variations and modifications may be made to the embodiments described herein to adapt it to various usages and conditions.

We claim:

1. A combined fuel cell and heat exchanger stack assembly comprising:
a first electrically conductive plate having first and second sets of spaced apart fluid openings, the first and second sets of openings being spaced apart from each other, at least one fluid channel fluidly connecting one fluid opening in the first set with at least one fluid opening in the second set;
a second electrically conductive plate having first and second sets of spaced apart fluid openings, the first and second sets of openings being spaced apart from each other, at least one fluid channel fluidly connecting one fluid opening in the first set with at least one fluid opening in the second set;
a heat exchanger plate having first and second sets of spaced apart heat exchanger fluid openings, the first and second sets of heat exchanger openings being spaced apart from each other, at least one fluid channel fluidly connecting one heat exchanger fluid opening in the first set with at least one heat exchanger fluid opening in the second set, the heat exchanger plate being sandwiched between the first and second electrically conductive plates so that the spaced apart fluid openings in the plates and the fluid channels are in fluid communication with each other;
the first electrically conductive plate, the second electrically conductive plate and the heat exchanger plate being configured such that thermal energy generated at the heat exchanger plate preheats a fuel cell fluid reactant as it enters the at least one fluid channel in the second electricially conductive plate at a first temperature to a second temperature by thermal energy transfer from the heat exchanger plate.

2. The assembly, according to claim 1, in which the first electricially conductive plate includes a first set of three manifold openings located near a first plate edge and a second set of three manifold openings located near a second plate edge opposite the first plate edge.

3. The assembly, according to claim 1, in which the second electrically conductive plate includes a first set of three manifold openings located near a first plate edge and a second set of three manifold openings located near a second plate edge opposite the first plate edge.

4. The assembly, according to claim 1, in which the heat exchanger plate includes a first set of three manifold openings located near a first plate edge and a second set of three manifold openings located near a second plate edge opposite the first plate edge.

5. The assembly, according to claim 2, in which the first electrically conductive plate includes first and second cooling fins connected to the plate and extending extending away therefrom, the cooling plates being respectively connected to a third and a fourth plate edge.

6. The assembly, according to claim 2, in which in the first electrically conductive plate, the first set of the three manifold openings includes: an oxidant outlet manifold opening, a heat exchanger inlet manifold opening and an anode outlet manifold opening; and the second set of the three manifold openings includes: an oxidant inlet manifold opening, a heat exchanger outlet manifold opening and an anode inlet manifold opening.

7. The assembly, according to claim 6, in which the at least one fluid channel connects the anode inlet manifold opening to the anode outlet manifold opening.

8. The assembly, according to claim 6, in which three fluid channels connect the anode inlet manifold opening to the anode outlet manifold opening.

9. The assembly, according to claim 8, in which the fluid channels are serpentine.

10. The assembly, according to claim 1, in which the at least one fluid channel is located on one side of the first electrically conductive plate.

11. The assembly, according to claim 1, in which the first electrically conductive plate is an anode plate.

12. The assembly, according to claim 3, in which in the second electrically conductive plate, the first set of the three manifold openings includes: an oxidant outlet manifold opening, a heat exchanger inlet manifold opening and an cathode outlet manifold opening; and the second set of the three manifold openings includes: an oxidant inlet manifold opening, a heat exchanger outlet manifold opening and an cathode inlet manifold opening.

13. The assembly, according to claim 12, in which the at least one fluid channel connects the anode inlet manifold opening to the anode outlet manifold opening.

14. The assembly, according to claim 13, in which three fluid channels connect the anode inlet manifold opening to the anode outlet manifold opening.

15. The assembly, according to claim 14, in which the fluid channels are disposed in a serpentine flow field pattern.

16. The assembly, according to claim 1, in which the at least one fluid channel is located on one side of the second electrically conductive plate.

17. The assembly, according to claim 1, in which the first electrically conductive plate is a cathode plate.

18. The assembly, according to claim 4, in which in the heat exchanger plate, the first set of the three manifold openings includes: an oxidant outlet manifold opening, a heat exchanger inlet manifold opening and an cathode outlet manifold opening; and the second set of the three manifold openings includes: an oxidant inlet manifold opening, a heat exchanger outlet manifold opening and an cathode inlet manifold opening.

19. The assembly, according to claim 18, in which the at least one fluid channel connects the anode inlet manifold opening to the anode outlet manifold opening.

20. The assembly, according to claim 18, in which three fluid channels connect the anode inlet manifold opening to the anode outlet manifold opening.

21. The assembly, according to claim 20, in which the fluid channels are disposed in a serpentine flow field pattern.

22. The assembly, according to claim 1, in which in each of the first electrically conductive plate, the second electrically conductive plate and the heat exchanger plate, the fluid channels are located on one side of the plate, the other side of each plate has a smooth surface.

23. The assembly, according to claim 22, in which the fluid channels of each plate are orienated such that the fluid channels on the heat exchanger plate are in intimate contact with the smooth surface of the first electrically conductive plate and the smooth surface of the heat exchanger plate is in intimate contact with the smooth surface of the second electrically conductive plate, the fluid channels of the first electrically conductive plate and the fluid channels of the second electrically conductive plate being disposed away from each other.

24. The assembly, according to claim 1, in which the fuel cell fluid reactant is hydrogen gas.

25. The assembly, according to claim 24, in which the hydrogen gas is preheated to the first temperature, the first temperature being at least 20.37 K (−252.78 C).

26. The assembly, according to claim 1, in which the second temperature of the preheated hydrogen gas is 60° C.

27. The assembly, according to claim 26, in which the second temperature is the operating temperature of the stack.

28. The assembly, according to claim 1, in which the reactant gas exits the assembly at a third temperature, the third temperature being 60° C.

29. The assembly, according to claim 1, in which the cooling fins are connected to the anode plate and extend away therefrom.

30. The assembly, according to claim 1, in which the cooling fins are connected to the cathode plate and extend away therefrom.

31. The assembly, according to claim 1, in which the cooling fins are connected to the heat exchanger plate and extend away therefrom.

32. The assembly, according to claim 1, in which two of the fluid openings in both sets in each of the first and second electrically conductive plates, and the heat exchanger plate, are fluid reactant openings.

33. The assembly, according to claim 3, in which the at least one fluid channel extends between the two fluid openings.

34. The assembly, according to claim 4, in which three fluid channels extend between the two fluid openings.

35. The assembly, according to claim 5, in which the three fluid channels are disposed substantially parallel to each other.

36. A combined fuel cell and heat exchanger stack assembly, the assembly comprising:
a plurality of combined fuel cell and heat exchange assemblies, as claimed in claim 1, stacked on each other;
a plurality of cooling fins extending away from the stack, the cooling fins being located on opposite sides of the stack, the cooling fins being connected to opposite sides of each first electrically conductive plate;
an upper end plate and a lower end plate located in intimate contact with respectively an end first electrically conducitve plate and an end second electrically conductive plate.

37. The assembly, according to claim 36, in which the lower end plate includes an anode outlet manifold port, a heat exchanger inlet manifold port and an oxidant outlet manifold port.

38. The assembly, according to claim 36, in which the upper end plate includes an anode inlet manifold port, a heat exchanger outlet manifold port and an oxidant inlet manifold port.

39. The assembly, according to claim 1, operates autonomously.

40. The assembly, according to claim 36, operates autonomously.

41. A method for preheating a fuel cell reactant gas for use in a fuel cell stack, the method comprising:
heating a fuel cell fluid reactant as it enters an at least one fluid channel in a first electrically conductive plate, at a first temperature, from the first temperature to a second temperature by diverting thermal energy generated at a heat exchanger plate, the heat exchanger plate being sandwiched between the first electrically conductive plate and a second electrically conductive plate, the plates being in fluid communication with each other.
